(19) United States
(12) Patent Application Publication
(10) Pub. No.: US 2007/0213647 A1
(43) Pub. Date: Sep. 13, 2007

(54) Dental hygiene apparatus

(76) Inventor: Frank A. Incardona, Dallas, TX (US)

Correspondence Address: SCOTT T. GRIGGS, 901 MAIN STREET, SUITE 6300, DALLAS, TX, 75202, US

(21) Appl. No.: 11/370,674

(22) Filed: Mar. 7, 2006

(51) Int. Cl. A61H 7/00

(52) U.S. Cl. 601/165; 601/162; 601/160; 433/80

(57) ABSTRACT

A dental hygiene apparatus is disclosed for use in combination with a shower head of the type that discharges a pulsating stream of water through at least one discharge port. In one embodiment, a discharge cone having a socket surrounds the at least one discharge port. A water supply input coupling member having a plug releasably engages the discharge cone in an operative coupling position. An oral cleaning device is connected to the water supply input coupling member by a flexible tubular input line.

### TECHNICAL FIELD OF THE INVENTION

This invention relates, in general, to dental hygiene and, in particular, to a dental hygiene apparatus for use in combination with a shower head of the type that discharges a pulsating stream of water through at least one discharge port.

### BACKGROUND OF THE INVENTION

Dental hygiene apparatuses and, in particular, dental hygiene apparatuses that clean narrow slots between teeth are important tools in maintaining healthy teeth and minimizing dental problems. Existing commercially available dental hygiene apparatuses typically include electrically powered pump equipment that excludes use in a shower. Alternatively, the existing commercially available dental hygiene apparatuses include expensive aerator valves to provide a pulsating effect. Accordingly, a need exists for a dental hygiene apparatus which may be used in the shower and does not rely on electrically powered pump equipment or expensive aerator valves.

### SUMMARY OF THE INVENTION

A dental hygiene apparatus is disclosed for use in combination with a shower head of the type that discharges a pulsating stream of water through at least one discharge port. The dental hygiene apparatus allows an operator to releasably connect the dental hygiene apparatus and use the dental hygiene apparatus to hygienically clean his teeth during normal showering activities.

The dental hygiene apparatus taught herein does not rely on either electrically powered pump equipment or expensive aerator valves to provide a pulsating stream of water. Rather, during operation, the pulsating water flow produced by the shower head flows directly through the dental hygiene apparatus and is discharged as pulsating water flow. In one embodiment, a discharge cone having a socket surrounds the at least one discharge port. A water supply input coupling member having a plug that mates with the socket releasably engages the discharge cone in an operative coupling position. An oral cleaning device is connected to the water supply input coupling member by a flexible tubular input line.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a front perspective view of one embodiment of a shower head including a dental hygiene apparatus mounted thereto;

FIG. 2 is an exploded view of the shower head depicted in FIG. 1;

FIGS. 3A and 3B are front perspective views of components of the dental hygiene apparatus; namely, one embodiment of a water supply input coupling member being inserted into a discharge cone;

FIGS. 4A, 4B, and 4C are a cross-sectional view of the water supply input coupling member being inserted into the discharge cone of FIGS. 3A and 3B;

FIGS. 5A and 5B are front perspective views of components of the dental hygiene apparatus; namely, another embodiment of a water supply input coupling member being inserted into a discharge cone; and

FIGS. 6A and 6B cross-sectional views of the water supply input coupling member of FIGS. 5A and 5B releasably engaging the discharge cone.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

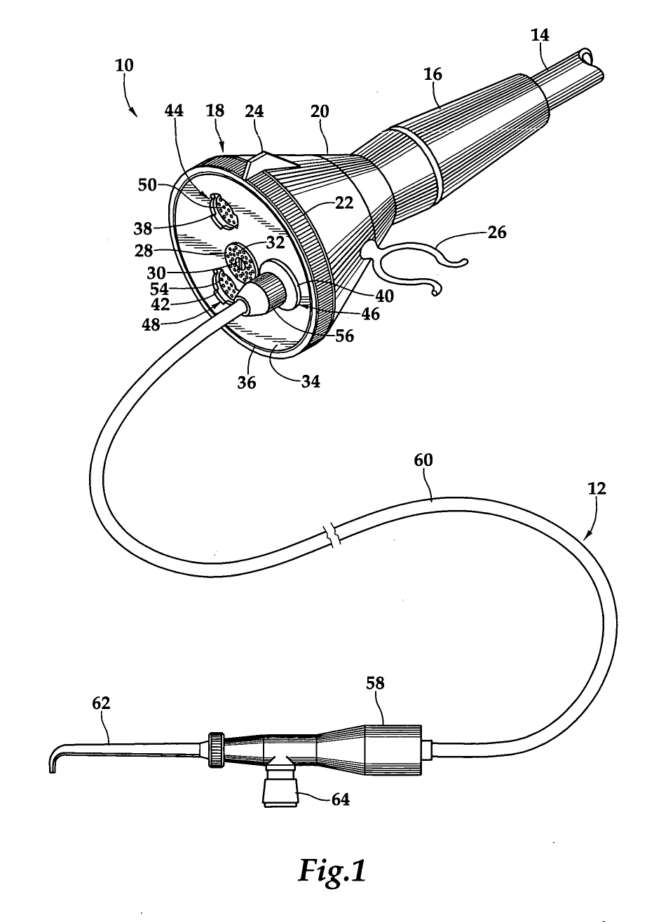

Referring initially to FIG. 1, therein is depicted a shower head 10 including a dental hygiene apparatus 12 mounted thereto. A water source provides the shower head 10 water via a pipe 14. More specifically, the pipe 14 delivers water to a body 16, which houses a misting device, that is coupled to a conical head portion 18. The misting device in combination with the components within the conical head portion 18 deliver both a pulsating stream of water and water mist to a user during operation. It should be appreciated, however, that the shower head 10 may deliver different types of water flow and spray patterns in addition to a pulsating stream of water and a water mist. For example, in addition to providing a pulsating stream of water, the shower head 10 may provide a champagne setting, soft champagne setting, aerated setting, or a setting combination thereof, for example.

A control ring 20 encircles all of the components of the conical head portion 18 and includes a forward-facing series of flutes 22 for grasping by the fingers of the user to orient the rotation of the control ring 20. A radial ear 24 indicates the rotational position which provides for different water settings such as a pulsating stream of water, a water mist, or a combinational setting thereof. An optionally storage bracket 26 is utilized in the embodiment of FIG. 1 and disposed on the control ring 20 for releasably securing the dental hygiene apparatus 12 when the dental hygiene apparatus 12 is not in use.

A central orifice plate 28 is secured to the conical head portion 18 by a screw 30. A distributed array of emitter apertures 32 provide a water mist through the central orifice plate 28. A front cover 34 circumferentially spans the region between the central orifice plate 28 and the control ring 20. A seal 36 is disposed between the front cover 34 and the control ring 20 to provide closure therebetween.

Three discharge cones 38, 40, 42 are integrally formed within the front cover 34 to provide openings that respectively circumscribe each of three circumferentially spaced mist groupings 44, 46, 48 which each include a plurality of discharge ports 50, 52, 54; of which, discharge port 52 is obscured in FIG. 1 by the dental hygiene apparatus 12. In the illustrated embodiment, the plurality of discharge ports 50, 52, 54 provide pulsating streams of water.

As will be discussed in additional detail hereinbelow, in one embodiment, each of the discharge cones 38, 40, 42 includes a socket. The dental hygiene apparatus 12 includes a water supply input coupling member 56 having a plug that is adapted for insertion into any of the three discharge cone sockets and releasably engaging with the discharge cone 40 in an operative coupling position which is depicted in FIG. 1. An oral cleaning device 58 is connected to the water supply input coupling member 56. More specifically, a tubular input line 60, which includes a portion of flexible polymer tubing; is coupled to the water supply input coupling member 56. The oral cleaning device 58 includes a discharge syringe 62 for delivery of the pulsating water stream.

In the illustrated embodiment, the discharge syringe 58 further comprises a control vale 64 including a valve element and cooperative valve seat for adjustment to provide a metered water flow and adjust the pressure of the pulsating water flow to suit personal preference. The discharge syringe 58, however, may be more or less complicated. For example, the discharge syringe 58 may include only a cleaning tip without any control valves. Regardless of the complexity of the discharge syringe 58, an operator can control the temperature and pressure of the pulsating water flow to suit personal comfort and preference by adjusting the hot and cold water valves that control water flow to the shower head 10. It should be appreciated that the dental hygiene apparatus 12 taught herein works with shower heads other than the one presented in FIG. 1. The dental hygiene apparatus 12 may be utilized with any style of shower head.

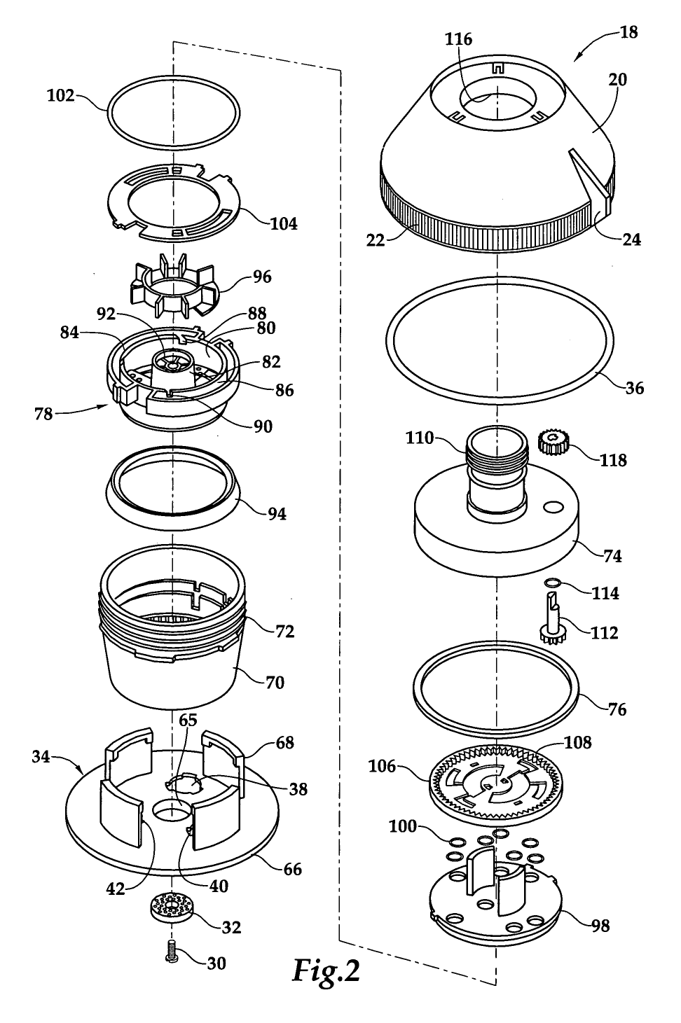

FIG. 2 depicts the shower head 10 and, in particular, the conical head portion 18 in further detail. As previously discussed, the central orifice plate 28 is secured within an opening 65 of the front cover 34 to the conical head portion 18 by the screw 30. Additionally, as discussed, the front cover 34 with the seal 36 circumferentially spans the region between the central orifice plate 28 and the control ring 20. The front cover 34 includes an annular band 66 and several ring segments 68 coupled thereto. The ring segments 68 engage an annular housing 70 which is threaded at 72 to receive a cup-shaped connector 74 which is sealed thereto by a gasket 76. Numerous components are housed within the space defined by the annular housing 70 and the cup-shaped connector 74.

More particularly, an orifice cup 78, which defines an internal vortex chamber 80 that surrounds a tube 82, is seated within the forward end portion of the annular housing 70. The orifice cup 78 also includes troughs 84, 86 having nozzles 88, 90, respectively, for assisting in dispensing pulsating water flow. A spider 92 is seated withing the tube 82 and a seal 94 is positioned around the periphery of the orifice cup 78.

Seated freely within the internal vortex chamber 80 is a turbine 96. A flow director 98 having numerous small seals 100, a seal 102, and resilient gasket 104 are seated adjacent to the orifice cup 78 within the annular housing 70. Seated immediately to the rear of the flow director 98 is a control plate 106 having a ring gear 108. The cup-shaped connector 74 restrains the control plate 106 in a position against the flow director 98. An externally threaded tube 110 projects outwardly and integrally from the cup-shaped connector 74. Further, a geared shaft 112 having an O-ring seal 114 projects through the threaded tube 110 to mate with the ring gear 108. Another ring gear (which is not illustrated), formed within the control ring skirt 116, mates with a spur gear 118 attached to the rearward end of the geared shaft 112 so as to drive the latter in rotation and thereby rotate the control plate 106.

In operation, a gear chain, which is formed by the forward-facing series of flutes 22, the ring gear formed within the control ring skirt 116, the spur gear 118, the geared shaft 112, and the ring gear 108, controls the positioning of the control plate 106 and therefore the director plate 98 and desired water setting. The director plate 98 includes apertures respectively aligned with passages so as to communicate water through the conical head portion 18 of the shower head 10 and in particular from the threaded tube 110 to the tube 82 of the orifice cup 78 to the central orifice plate 28 for the water mist. For the pulsating stream of water, the communication path is from the threaded tube 110 to the troughs 84, 86 and nozzles 88, 90 of the orifice cup 78 to the discharge cones 38, 40, 42 and discharge ports 50, 52, 54 of the front cover 37. Similar to the pulsating stream of water communication path, for the pulsating stream of water that is used in the dental hygiene apparatus, the communication path is from the threaded tube 110 to the troughs 84, 86 and nozzles 88, 90 of the orifice cup 78 to one of the discharge cones 38, 40, 42 of the front cover 37 to the water supply input coupling member 56 and finally, the tubular input line 60 and oral cleaning device 58.

The positioning of the director plate 98 determines the amount of water provided to both the internal vortex chamber 80 and to the troughs 84, 86, thereby determining the water setting. By way of example, when the director plate 98 terminates water flow through the troughs 84, 86 and nozzles 88, 90, the shower head 10 delivers a water mist through both the distributed array of emitter apertures 32 and the discharge ports 50, 52, 54. To the contrary, when the director plate 98 provides water flow to internal vortex chamber 80 and troughs 84, 86, the shower head 10 delivers a water mist through the distributed array of emitter apertures 32 and a pulsating water stream through the plurality of discharge ports 50, 52, 54. This latter setting which is under the control of the control ring 20 is utilized in the illustrated embodiment in conjunction with the dental hygiene apparatus 12 to ensure a pulsating stream of water of hygienic cleaning.

In one implementation, a quick-acting coupling including a plug and socket configuration is used in conjunction with the dental hygiene apparatus 12 presented herein. When properly connected, the plug and socket configuration seals and locks the joint between one of the discharge cones 38, 40, 42 of the shower head 10 and the oral cleaning device 58 via water supply input coupling member 56 and tubular input line 60 in order to effectively contain internal pressures and resist any tensile forces that may tend to pull the joint apart. Preferably, the joint formed by the plug and socket configuration is operable to be connected and disconnected without the use of tools.

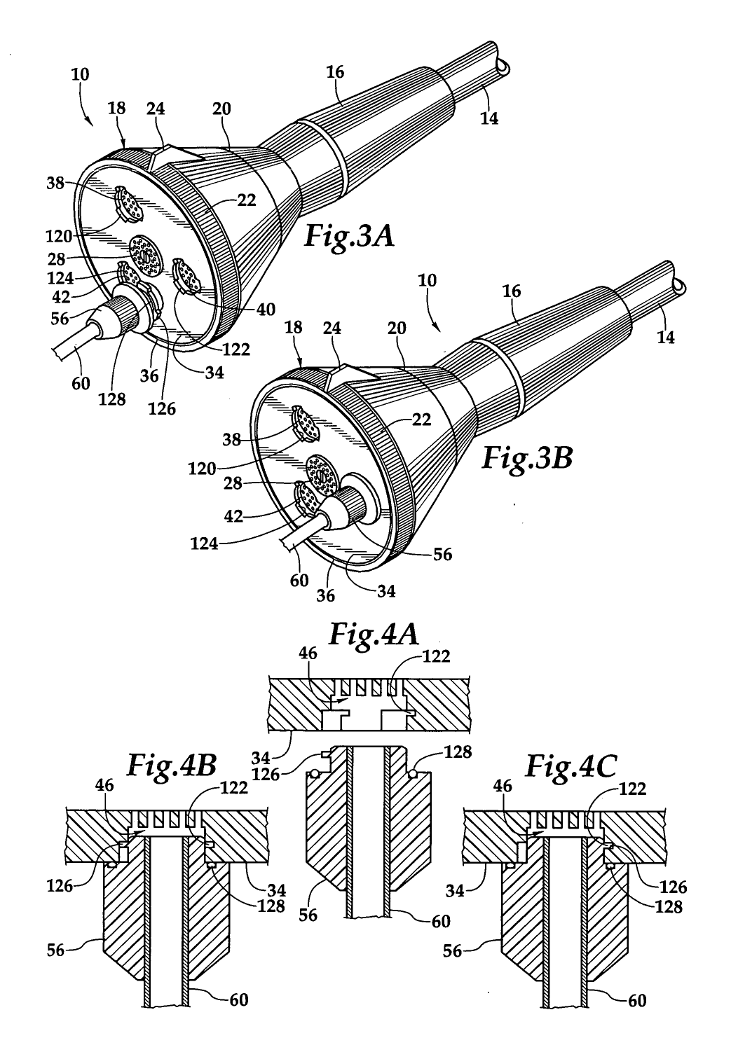

The socket may be disposed at a discharge cone 38, 40, 42 of the shower head 10 and the plug may be disposed at the water supply input coupling member 56. The socket and plug may define a ball-lock coupling, a roller-lock coupling, a pin-lock coupling, a flat-face coupling, a no spill coupling, a bayonet coupling, a ring-lock coupling, a cam-lock coupling, or a box and pin coupling, for example. Preferably, a bayonet coupling or a box and pin coupling is utilized as illustrated by the embodiments provided in FIGS. 3A through 6B.

FIGS. 3A and 3B as well as FIGS. 4A, 4B, and 4C depict components of the dental hygiene apparatus; namely, the discharge cones 38, 40, 42 of the front cover 34 and the water supply input coupling member 56 being inserted into the discharge cone 40. In the illustrated bayonet coupling embodiment, each discharge cone 38, 40, 42 is radially undercut or intersected by a slot in order to form a socket and annular coupling slots 120, 122, 124 therein. Although the illustrated discharge cones 38, 40, 42 depict only one annular coupling slot each, the illustrated discharge cones 38, 40, 42 may have more than one annular coupling slots. Further, preferably, the annular coupling slots 120, 122, 124 are an OEM offering and are machined when the shower head components are being manufactured. It should be understood that only one discharge cone 38, 40, 42 needs to be equipped with an annular coupling slot in order to practice the present invention. By increasing the number of discharge cones 38, 40, 42 having annular couplings, however, the number of connection options is increased and the convenience to the operator is increased.

The water supply input coupling member 56 includes a plug defined by a bayonet-type flange portion 126 for releasably coupling with one of the annular coupling slots 120, 122, 124 of the front cover 34. In other implementations, the bayonet-type flange portion 126 may comprise a lug. An annular seal gasket 128 is coupled to the bayonet-type flange portion 126 for forming a water-tight seal between one of the discharge cones 38, 40, 42 and the water supply input coupling member 56 when the water supply input coupling member 56 is in the operative coupling position. In one implementation, the annular seal gasket 128 comprises an O-ring seal.

The FIGS. 3A through 4C also depict the water supply input coupling member 56 being inserted and releasably secured to the discharge cone 40. Initially, as best seen in FIGS. 3A and 4A, the bayonet-type flange portion 126 of the water supply input coupling member 56 is axially aligned with the complimentary annular coupling slot 122 and the water supply input coupling member 56 is inserted into the discharge cone 40. As best illustrated in FIGS. 3B, 4B, and 4C, once the bayonet-type flange portion 126 is inserted into the slot 122 and the discharge cone 40, the bayonet-type flange portion 126 is rotated into a releasable locking engagement. Once in this position, a pulsating water stream flows from the circumferentially spaced mist grouping 46 of the shower head 10 to the oral cleaning device 58 via the water supply input coupling 56. To release the joint formed by the bayonet-type flange portion 126 and the annular coupling slot 122, the bayonet-type flange portion 126 is rotated in the opposite direction and then pulled away from the shower head 10.

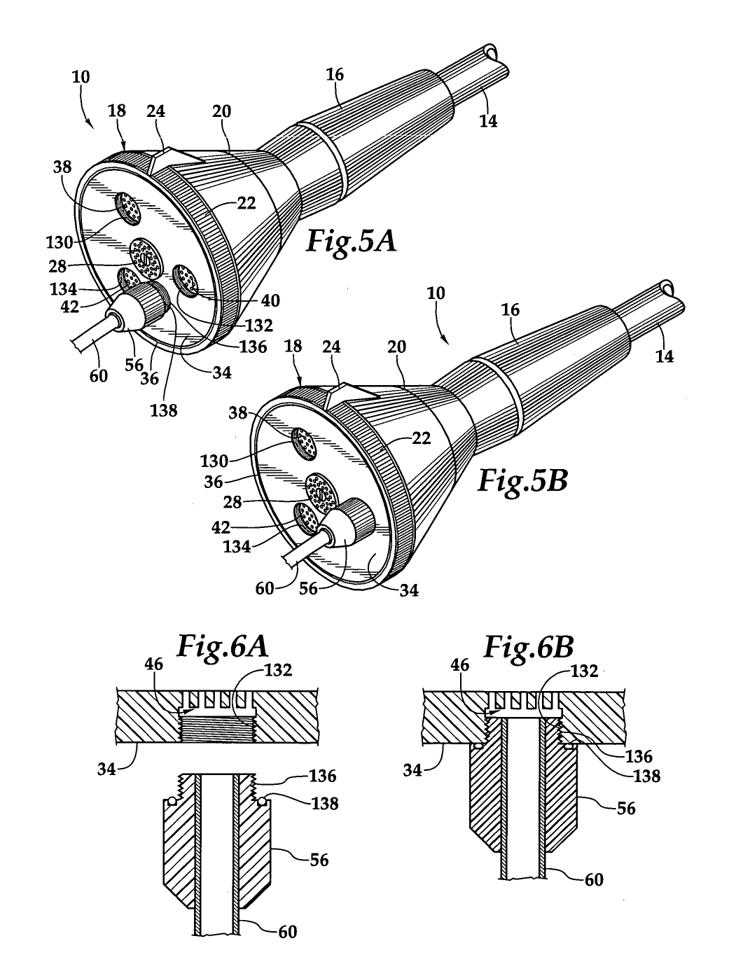

FIGS. 5A, 5B, 6A, and 6B depict another embodiment of the discharge cones 38, 40, 42 of the front cover 34 and the water supply input coupling member 56. This embodiment depicts the box and pin coupling discussed hereinabove. As best seen in FIGS. 5A and 5B, each discharge cone 38, 40, 42 includes a socket or box comprising threads 130, 132, 134 that respectively surround the plurality of discharge ports 50, 52, 54. In this embodiment, the water supply input coupling member 56 includes a threaded bushing 136, i.e., the plug or pin, adapted for releasably mating with the threads 132 of the discharge cone 40 as best seen with reference to FIGS. 6A and 6B. An annular seal gasket 138, which is similar to annular seal gasket 128, provides a water tight seal. To secure the joint formed by the threads 132 of the discharge cone 40 and the threaded bushing 136, the threaded bushing 136 is axially aligned with the discharge cone 40 and inserted therein. Torque is then applied to the threaded bushing 136 to complete the coupling. Similar to releasing the water supply input coupling member 56 in FIGS. 3A through 4C, torque is applied in the opposite direction and the water supply input coupling 56 is pulled away from the shower head 10.

Accordingly, the dental hygiene apparatus taught herein utilizes the pulsating water flow produced by a shower head to provide pulsating water flow to an oral cleaning device for dental hygiene. This is accomplished, in part, by utilizing a shower head discharge cone having a socket and a water supply input coupling, which has a corresponding plug, attached to the oral cleaning device. The plug and socket form a joint that releasably connects the shower head and the oral cleaning device. As previously discussed, the dental hygiene apparatus may be quickly connected and disconnected from the shower head for use during normal showering activities and for cleaning and storage when not in use.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A dental hygiene apparatus for use in combination with a shower head of the type that discharges a pulsating stream of water through at least one discharge port, the dental hygiene apparatus comprising:
a discharge cone surrounding the at least one discharge port, the discharge cone intersected by an annular coupling slot which surrounds the at least one discharge port;
a water supply input coupling member including a bayonet-type flange portion adapted for insertion into the annular coupling slot and releasably engaging with the discharge cone in an operative coupling position; and
an oral cleaning device connected to the water supply input coupling member.

2. The dental hygiene apparatus as recited in claim 1, further comprising an annular seal gasket coupled to the bayonet-type flange portion for forming a water-tight seal between the discharge cone and the water supply input coupling member when the water supply input coupling member is in the operative coupling position.

3. The dental hygiene apparatus as recited in claim 2, wherein the annular seal gasket comprises an O-ring seal.

4. The dental hygiene apparatus as recited in claim 1, further comprising a storage bracket mounted to the shower head, the storage bracket for releasably securing the oral cleaning device.

5. The dental hygiene apparatus as recited in claim 1, wherein the oral cleaning device further comprises a discharge syringe.

6. The dental hygiene apparatus as recited in claim 5, wherein the discharge syringe further comprises a control vale, the control valve including a valve element and cooperative valve seat for adjustment to provide a metered water flow.

7. The dental hygiene apparatus as recited in claim 1, further comprising a tubular input line that connects the water supply input coupling member to the oral cleaning device.

8. A dental hygiene apparatus for use in combination with a shower head of the type that discharges a pulsating stream of water through at least one discharge port, the dental hygiene apparatus comprising:
a discharge cone surrounding the at least one discharge port, the discharge cone having threads which surround the at least one discharge port;
a water supply input coupling member including a threaded bushing adapted for mating with the threads of the discharge cone and releasably engaging the discharge cone in an operative coupling position; and
an oral cleaning device connected to the water supply input coupling member.

9. The dental hygiene apparatus as recited in claim 8, further comprising an annular seal gasket mounted on the threaded bushing for forming a water-tight seal between the discharge cone and the water supply input coupling member when the water supply input coupling member is in the operative coupling position.

10. The dental hygiene apparatus as recited in claim 9, wherein the annular seal gasket comprises an O-ring seal.

11. The dental hygiene apparatus as recited in claim 8, further comprising a storage bracket mounted to the shower head, the storage bracket for releasably securing the oral cleaning device.

12. The dental hygiene apparatus as recited in claim 8, wherein the oral cleaning device further comprises a discharge syringe.

13. The dental hygiene apparatus as recited in claim 12, wherein the discharge syringe further comprises a control vale, the control valve including a valve element and cooperative valve seat for adjustment to provide a metered water flow.

14. The dental hygiene apparatus as recited in claim 8, further comprising a tubular input line that connects the water supply input coupling member to the oral cleaning device.

15. A dental hygiene apparatus for use in combination with a shower head of the type that discharges a pulsating stream of water through at least one discharge port, the dental hygiene apparatus comprising:
a discharge cone surrounding the at least one discharge port, the discharge cone having a socket disposed therein;
a water supply input coupling member including a plug for releasably engaging the discharge cone in an operative coupling position; and
an oral cleaning device connected to the water supply input coupling member.

16. The dental hygiene apparatus as recited in claim 15, wherein the socket and the plug form a coupling selected from the group consisting of ball-lock couplings, roller-lock couplings, pin-lock couplings, flat-face couplings, no spill couplings, bayonet couplings, ring-lock couplings, cam-lock couplings, and box and pin couplings.

17. The dental hygiene apparatus as recited in claim 15, wherein the oral cleaning device further comprises a discharge syringe.

18. The dental hygiene apparatus as recited in claim 15, further comprising a tubular input line that connects the water supply input coupling member to the oral cleaning device.

19. A dental hygiene apparatus for use in combination with a shower head of the type that discharges a pulsating stream of water through at least one discharge port, the dental hygiene apparatus comprising:
a discharge cone surrounding the at least one discharge port;
a water supply input coupling member including a means for releasably engaging the discharge cone in an operative coupling position; and
an oral cleaning device connected to the water supply input coupling member.

20. The dental hygiene apparatus as recited in claim 19, wherein the oral cleaning device further comprises a discharge syringe.
